(19) United States
(12) Patent Application Publication
(10) Pub. No.: US 2021/0142260 A1
(43) Pub. Date: May 13, 2021

(54) SYSTEM AND METHOD FOR MOVING A LAND RIG

(71) Applicant: Schlumberger Technology Corporation, Sugar Land, TX (US)

(72) Inventor: Jean-Christophe Priser, Katy, TX (US)

(21) Appl. No.: 16/680,939

(22) Filed: Nov. 12, 2019

(51) Int. Cl. G06Q 10/06; G06Q 50/08; G06Q 10/10

(52) U.S. Cl. CPC G06Q 10/063112; G06Q 10/1053; G06Q 50/08; G06Q 10/063114

(57) ABSTRACT

A method includes receiving a list of personnel that will perform a job. The method also includes receiving a list of equipment that will perform the job. The method also includes scanning identification devices a first time to produce first identification information when a contractor, personnel, and equipment arrive at a jobsite. The method also includes comparing, using the client computer, the first identification information to the list of personnel and the list of equipment. The method also includes determining, using the client computer, that the personnel in the first identification information match the personnel listed in the list of personnel based upon the comparison. The method also includes determining, using the client computer, that the equipment in the first identification information matches the equipment listed in the list of equipment based upon the comparison. The method also includes granting the contractor authorization to commence the job.

### BACKGROUND

A land rig is a drilling rig that is designed to drill wellbores at onshore locations. Some land rigs are designed to be moved from one location to another. In order to move the land rig, the components of the land rig are first disassembled (e.g., using a crane). The components are then transported to a new location (e.g., using one or more trucks). The components are then re-assembled (e.g., using the crane).

Oftentimes, the job of moving the land rig is not performed by the same people that are responsible for the drilling, completion, production, and/or workover operations. Rather, the job of moving the land rig may be assigned to a contractor. Sometimes the contractor may assign portions of the job to one or more sub-contractors. The contractor and/or sub-contractors may provide the equipment to that is used move the land rig (e.g., the crane and trucks). With so many moving people and parts during the moving of the land rig, it may be difficult to monitor the contractor, the sub-contractors, and their equipment to ensure that they are approved to do the portion of the job to which they are assigned. If it is determined that one or more people or items of equipment are not approved, then the moving of the land rig is halted until the people or items of equipment are approved, or different people or items of equipment are brought in that are approved. Halting the moving of the land rig may waste time, which may lead to lost profits.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method includes receiving a list of personnel that will perform a job. The list of personnel is transmitted from a contractor using a contractor web access application on a contractor computer to a client computer. The method also includes receiving a list of equipment that will perform the job. The list of equipment is transmitted from the contractor using the contractor web access application on the contractor computer to the client computer. The list of equipment includes information about the equipment. The method also includes providing a plurality of identification devices to the contractor. A first of the identification devices is to be worn by the contractor, a second of the identification devices is to be worn by one of the personnel, and a third of the identification devices is to be coupled to the equipment. The method also includes scanning the identification devices a first time to produce first identification information when the contractor, the personnel, and the equipment arrive at a jobsite. The method also includes comparing, using the client computer, the first identification information to the list of personnel and the list of equipment. The method also includes determining, using the client computer, that the personnel in the first identification information match the personnel listed in the list of personnel based upon the comparison. The method also includes determining, using the client computer, that the equipment in the first identification information matches the equipment listed in the list of equipment based upon the comparison. The method also includes granting the contractor authorization to commence the job based at least partially upon the determination that the personnel in the first identification information match the personnel listed in the list of personnel and the determination that the equipment in the first identification information matches the equipment listed in the list of equipment.

A method for moving a land rig is also disclosed. The method includes determining that a contractor is approved to move the land rig. The method also includes providing the contractor access to a contractor web access application on a contractor computer after the contractor is approved to move the land rig. The method also includes receiving a list of personnel that will move the land rig from the contractor. The list of personnel is transmitted by the contractor through the contractor web access application to a client computer. The method also includes receiving a list of equipment that will move the land rig from the contractor. The list of equipment is transmitted by the contractor through the contractor web access application to the client computer. The list of equipment includes a certification of the equipment and a validity period for the certification. The method also includes determining, using the client computer, that the personnel in the list of personnel are approved to perform the job by comparing past experience and certifications of the personnel to first predetermined standards. The method also includes determining, using the client computer, that the equipment in the list of equipment is approved to perform the job by comparing certifications of the equipment to second predetermined standards. The method also includes providing a plurality of identification devices to the contractor. A first of the identification devices is to be worn by the contractor, a second of the identification devices is to be worn by one of the personnel, and a third of the identification devices is to be coupled to the equipment. The method also includes scanning the identification devices a first time to produce first identification information when the contractor, the personnel, and the equipment arrive at a location of the land rig. The method also includes comparing, using the client computer, the first identification information to the list of personnel and the list of equipment. The method also includes determining, using the client computer, that the personnel in the first identification information match the personnel listed in the list of personnel based upon the comparison. The method also includes determining, using the client computer, that the equipment in the first identification information matches the equipment listed in the list of equipment based upon the comparison. The method also includes granting the contractor authorization to commence moving the land rig based at least partially upon the determination that the personnel in the list of personnel are approved to move the land rig, the determination that the equipment in the list of equipment is approved to move the land rig, the determination that the personnel in the first identification information match the personnel listed in the list of personnel, and the determination that the equipment in the first identification information matches the equipment listed in the list of equipment.

A system for moving a land rig is also disclosed. The system includes a scanning device configured to scan a plurality of identification devices a first time to produce first identification information. A first of the identification devices is worn by a contractor, a second of the identification devices is worn by personnel of the contractor, and a third of the identification devices is coupled to equipment. The system also includes a client computer configured to perform operations. The operations include receiving a list of personnel that will move the land rig from the contractor. The list of personnel includes the personnel that wears the second identification device. The operations also include receiving a list of equipment that will move the land rig from the contractor. The list of equipment includes the equipment that has the third identification device coupled thereto. The operations also include comparing the first identification information to the list of personnel and the list of equipment. The operations also include determining that the personnel in the first identification information match the personnel listed in the list of personnel based upon the comparison. The operations also include determining that the equipment in the first identification information matches the equipment listed in the list of equipment based upon the comparison. The operations also include granting the contractor authorization to commence moving the land rig based at least partially upon the determination that the personnel in the first identification information match the personnel listed in the list of personnel and the determination that the equipment in the first identification information matches the equipment listed in the list of equipment.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a system for performing a job (e.g., moving a land rig), according to an embodiment.

FIGS. 2A and 2B illustrate a flowchart of a method for moving a land rig, according to an embodiment.

FIG. 3 illustrates a schematic view of a computing system for performing at least a portion of the method, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

FIG. 1 illustrates a schematic view of a system 100 for performing a job (e.g., moving a land rig 160), according to an embodiment. The system 100 may include a client central computer 110 that belongs to a company in charge of the job. The client central computer 110 may be located at a jobsite or away from the jobsite (e.g., in another city, state, or country). As used herein, the jobsite refers to a wellsite where a job is to be performed (e.g., moving the land rig 160). A client 112 of the company in charge of the job may have access to upload information to the client central computer 110 and download information from the client central computer 110 when the client is located at the jobsite or away from the jobsite. The client 112 may also be referred to as the person in charge of the job.

The system 100 may also include a client location computer 120 that belongs to the company in charge of the job. As shown, the client central computer 110 may be located away from the jobsite, and the client location computer 120 may be located at the jobsite. The client 112 (or another client) of the company in charge of the job may have access to upload information to the client location computer 120 and download information from the client location computer 110. As will be appreciated, the client central computer 110 and the client location computer 120 may be configured to communicate with one another, such that the information uploaded to the client central computer 110 may be transmitted to the client location computer 120, and the information uploaded to the client location computer 120 may be transmitted to the client central computer 110.

The system 100 may also include a wireless access point 130 that belongs to the company in charge of the job. The wireless access point 130 may be located at the jobsite. The wireless access point 130 may be configured to facilitate wireless communication between the client location computer 120 and the client 112. For example, the client 112 may have a smart phone or tablet 114 that is configured to communicate with the client location computer 120 via the wireless access point 130.

The system 100 may be configured to communicate with a contractor computer 140. For example, the client central computer 110 and/or the client location computer 120 may be configured to communicate with the contractor computer 140. The contractor computer 140 may belong to a contractor 142 that has been hired by the company in charge of the job to perform at least a portion of the job. The contractor computer 140 may be located away from the jobsite or at the jobsite.

The contractor computer 140 may be configured to run one or more applications. For example, the contractor computer 140 may be configured to run a secured web application such as a contractor web access application 144 through which the contractor 142 may upload information to the client central computer 110 and/or client location computer 120. The contractor web access application 144 may also be used to download information from the client central computer 110 and/or client location computer 120.

The contractor computer 140 may be accessible in substantially real-time by the client central computer 110, the client location computer 120, the client 112 (via the smart phone or tablet 114), the contractor 142, or a combination thereof. In at least one embodiment, this may allow the client central computer 110, the client location computer 120, the client 112 (via the smart phone or tablet 114), and/or the contractor 142 to measure or monitor key performance indicators (KPI) and key performance objectives (KPO) of the contractor 142 in substantially real-time.

As described in greater detail below with regard to the method 200, the client 112 or company in charge of the job may hire the contractor 142 to perform at least a portion of the job. The contractor 142 may have personnel (one is shown: 146) that will assist with the job. The personnel 146 may be an employee or a sub-contractor. The contractor 142 and/or personnel 146 may use equipment 150 to perform at least a portion of the job. The equipment 150 may be or include a crane, a truck, etc.

FIGS. 2A and 2B illustrate a flowchart of a method 200 for moving the land rig 160, according to an embodiment. While the method 200 is described in the context of moving the land rig 160, it will be appreciated, that the method 200 may also or instead be applied to other oilfield operations that involve equipment and/or people (e.g., contractors, sub-contractors, etc.) that are to be approved prior to performing a job at a wellsite. An example of such other oilfield operations may be or include moving or operating a workover rig.

An illustrative order of the method 200 is provided below. However, it will be appreciated that one or more portions of the method 200 may occur in a different order or be omitted. In addition, one or more portions of the method 200 may be performed using a computing system, such as the client central computer 110, the client location computer 120, and/or the contractor computer 140. An illustrative computing system 300 is described below with respect to FIG. 3.

Phase 1—Approval and Onboarding

The method 200 may include determining that a contractor 142 is approved to perform a job, as at 202. For example, this may include determining that the contractor 142 is approved to move the land rig 160. The term contractor may also refer to a sub-contractor. The contractor 142 may be approved by a person (e.g., the client 112) or company in charge of the job. For example, the person or company may be in charge of the wellsite where the land rig 160 is being moved from, in charge of the wellsite site where the land rig 160 is being moved to, in charge of the land rig 160, or a combination thereof. The person or company in charge of the job may determine that the contractor 142 is approved to do the job by having the contractor 142 demonstrate the effectiveness of the implementation of his/her management system (e.g., standards and policies). In one embodiment, the person or company in charge of the job may determine that the contractor 142 is approved to do the job based at least partially upon the contractor's resume or past experience. In another embodiment, the person or company in charge of the job may determine that the contractor 142 is approved to do the job based at least partially upon the contractor's certifications. In addition, the contractor 142 may demonstrate that his/her resources (e.g., personnel 146, equipment 150, etc.) are approved to access the location and perform the job as per the client's specific standard local regulation, as described below. This may include site-specific induction, H2S training, illustrating that the crane and/or welding certifications are up-to-date, etc. Based on these factors, the person or company in charge of the job may determine that the contractor 142 is qualified to perform the job and subsequently approve the contractor 142 to perform the job.

The method 200 may also include providing the contractor 142 access to the contractor web access application 144, as at 204. The contractor 142 may be provided access by the person or company in charge of the job. The contractor web access application 144 may be accessed by the contractor 142 using the contractor computer 140, a tablet, a smart phone, etc. The contractor web access application 144 may be used to transmit, receive, and/or store data related to the job (e.g., moving the land rig 160). For example, the contractor 142 may be able to provide (e.g., upload) information to the client central computer 110 and/or the client location computer 120 using the contractor web access application 144. The information uploaded to the client central computer 110 and/or the client location computer 120 may include, for example, the lists described below at 206 and 208. The contractor 142 may also be able to receive (e.g., download) information from the client central computer 110 and/or the client location computer 120 using the contractor web access application 144. The information downloaded from the client central computer 110 and/or the client location computer 120 may include, for example, the details of the job and the qualifications and/or certifications to perform the job, notifications that occur during or after the job, or a post-job report, as discussed below.

The method 200 may also include receiving a list of personnel 146 that will perform the job from the contractor 142, as at 206. For example, the contractor 142 may use the contractor web access application 144 to transmit the list from the contractor computer 140 to the client central computer 110 and/or the client location computer 120. In at least one embodiment, the list of personnel may include the resume, past experience, certifications, and qualifications of each person 146 as well as the portion of the job to which each person 146 will be assigned.

The method 200 may also include receiving a list of equipment (e.g., machines, tools, etc.) 150 that will be used to perform the job from the contractor 142, as at 208. For example, the contractor 142 may use the contractor web access application 144 to transmit the list from the contractor computer 140 to the client central computer 110 and/or the client location computer 120. In at least one embodiment, the list of equipment may also include the portion of the job on which each piece of equipment 150 will be used as well as the certifications of each piece of equipment 150. The lists of personnel 146 and equipment 150 may also identify a validity period for each certification (e.g., identifying when they expire).

The method 200 may also include determining that the personnel 146 in the list of personnel are approved to perform at least a portion of the job, as at 210. The determination at 210 may be made by the client central computer 110, the client location computer 120, and/or the contractor computer 140. For example, the client central computer 110, the client location computer 120, and/or the contractor computer 140 may compare the information in the list of personnel at 206 to a list of predetermined standards (e.g., past experience, qualifications, certifications, etc.). The list of predetermined standards may be generated by the company in charge of the job or by an organization or association charged with promulgating such standards, such as, for example, the National Commission for the Certification of Crane Operators (NCCCO).

The method 200 may also include determining that the equipment 150 in the list of equipment is approved to perform at least a portion of the job, as at 212. The determination at 212 may be made by the client central computer 110, the client location computer 120, and/or the contractor computer 140. For example, the client central computer 110, the client location computer 120, and/or the contractor computer 140 may compare the information in the list of equipment at 208 to a list of predetermined standards (e.g., qualifications, certifications, etc.). The list of predetermined standards may be generated by the company in charge of the job or by an organization or association charged with promulgating such standards, such as, for example, the Crane Certification Association of America (CCAA). In at least one embodiment, the determination that the equipment 150 is approved may also be based at least partially upon a visual inspection of the equipment 150 (e.g., by the person in charge of the job or the contractor 142) when the equipment 150 arrives at the jobsite.

The method 200 may also include providing a plurality of identification devices (three are shown: 143, 147, 151) to the contractor 142, as at 214. For example, the identification device 143 may be assigned to the contractor 142, the identification device 147 may be assigned to the personnel 146, and the identification device 151 may be assigned to the equipment 150. The identification devices 143, 147 may be or include identification cards or badges that are to be worn by the contractor 142 and personnel 146 while they work on the job. The identification device 151 for the equipment 150 may be (e.g., permanently) coupled to the equipment 150 while the equipment 150 performs the job. Each identification device 143, 147, 151 may be unique. For example, each identification device 143, 147, 151 may be or include a different number or code. More particularly, each identification device 143, 147, 151 may be or include a different radio-frequency identification (RFID) tag, a different bar code, or the like. In one example, the identification device 147 may be used to help determine whether the personnel 146 working on the job is the same personnel that was previously-approved or if he/she is a last-minute substitution (e.g., a sub-contractor). In another example, the identification device 151 may be used to help determine whether the equipment 150 working on the job is the same equipment that was previously-approved or if it is a last-minute substitution (e.g., sub-contracted equipment).

Phase 2—Contractor Onsite Job Execution

When the contractor 142, the personnel 146, and/or the equipment 150 arrive at the jobsite (e.g., the wellsite), the method 200 may include scanning the identification devices 143, 147, 151 a first time to produce first identification information, as at 216. The identification devices 143, 147, 151 may be scanned by the person in charge of the job. The identification devices 143, 147, 151 may be scanned using a portable scanning device such as the smart phone or tablet 114. The scanning device may be (e.g., wirelessly) connected to the client central computer 110 and/or the client location computer 120.

The method 200 may also include transmitting the first identification information from the scanning device to the client central computer 110, the client location computer 120, and/or the contractor computer 140, as at 218. In at least one embodiment, upon the first identification information being received by the client central computer 110 and/or the client location computer 120, the person or company in charge of the job may be notified that the contractor 142, the personnel 146, and the equipment 150 have arrived at the jobsite and have been granted access to the jobsite. Similarly, upon the first identification information being received by the contractor computer 140, the contractor 142 may be notified that the personnel 146 and the equipment 150 have arrived at the jobsite and have been granted access to the jobsite.

Before commencing the job, a pre-job meeting may be held to discuss/confirm the scope of the job and/or the portions of the job that personnel 146 and equipment 150 may perform. Before, during, or after the pre job meeting, the method 200 may include scanning the identification devices 143, 147, 151 a second time to produce second identification information, as at 220. The identification devices 143, 147, 151 may be scanned by the person in charge of the job (or one of his/her employees) using the portable scanning device.

In one embodiment, the first scanning may be performed when the contractor 142, personnel 146, and equipment 150 arrive at the jobsite (e.g., to avoid unapproved people/equipment from accessing the location. The second scanning may be performed just prior to commencing the job. In an example, the contractor 142 may provide two 20-ton cranes and one 40-ton crane. A specific job may call for the 40-ton crane. The second scanning may help ensure that the 40-ton crane is being used, and the person operating the crane is the one that is the one that the contractor 142 previously indicated would operate the crane (e.g., he/she is certified).

The method 200 may also include transmitting the second identification information from the scanning device to the client central computer 110, the client location computer 120, and/or the contractor computer 140, as at 222. Thus, the second identification information from the scanning device may be received at the client central computer 110, the client location computer 120, and/or the contractor computer 140.

The method 200 may also include comparing the first or second identification information to the list of personnel at 206 and the list of equipment at 208, as at 224. The comparison may be performed by the client central computer 110, the client location computer 120, and/or the contractor computer 140.

The method 200 may also include determining that the personnel 146 identified in the first or second identification information match the personnel 146 in the list of personnel, as at 226. The method 200 may also include determining that the equipment 150 identified in the first or second identification information matches the equipment 150 in the list of equipment, as at 228. The determinations at 226 and 228 may be performed by the client central computer 110, the client location computer 120, and/or the contractor computer 140 and may be based at least partially upon the comparison at 224.

The method 200 may also include granting the contractor 142 authorization to commence the job, as at 230. The authorization to commence the job may be based at least partially upon the determination that the personnel 146 are approved to perform the job at 210, the determination that the equipment 150 is approved to perform the job at 212, the determination that the personnel 146 in the first or second identification information match the personnel 146 in the list of personnel at 226, the determination that the equipment 150 in the first or second identification information matches the equipment 150 in the list of equipment at 228, or a combination thereof.

The method 200 may also include determining whether/when any incidents occur during the job that delay completion of the job, as at 232. The determination at 232 may be made by the person in charge of the job 112 or by the contractor 142 (or his/her personnel 146). Illustrative incidents may be or include unsafe conditions or behavior, equipment not working properly, a delay in the job, etc.

The method 200 may also include determining whether/when one or more portions of the job is/are successfully completed, as at 234. The determination at 234 may be made by the person in charge of the job 112 (or one of his/her employees) or by the contractor 142 (or his/her personnel 146). For example, the person in charge of the job 112 (or one of his/her employees) may provide (e.g., upload) information directly or indirectly to the client central computer 110 and/or the client location computer 120 indicating that portions of the job are (or are not) successfully completed. In another example, the contractor 142 may provide (e.g., upload) information to the client central computer 110 and/or the client location computer 120, using the contractor web access application 144, indicating that portions of the job are (or are not) successfully completed.

In at least one embodiment, the method 200 may include generating a report, as at 236. The report may be generated by client central computer 110, the client location computer 120, and/or the contractor computer 140. The report may include the list of personnel 146, the list of equipment 150, the determination whether the personnel 146 in the list of personnel are approved, the determination whether the equipment 150 in the list of equipment is approved, the first identification information, the second identification information, a determination as to whether the personnel 146 and the equipment 150 in the first or second identification information match the personnel 146 and the equipment 150 in the lists, whether any incidents occurred, whether/when portions of the job are completed, or a combination thereof. The system 100 and method 200 may help to monitor the contractor 142, the personnel 146, and the equipment 150 from the approval/qualification process to the completion of the job.

The method 200 may also include notifying the person in charge of the job 112 and/or the contractor 142, as at 238. For example, the person in charge of the job 112 may be notified via the client central computer 110 and/or the client location computer 120. In another example, the client central computer 110 and/or the client location computer 120 may transmit instructions to the contractor web access application 144 to notify the contractor 142. The notification may indicate that the personnel 146 in the list of personnel are (or are not) approved, the equipment 150 in the list of equipment is (or is not) approved, the personnel 146 and the equipment 150 in the first or second identification information match (or do not match the personnel 146 and the equipment in the lists, an incident occurred, a portion of the job was (or was not completed), or a combination thereof.

Phase 3—Contractor Onsite Job Completion

After the job is completed, a post-job meeting may be held to discuss the job and/or the report. The contractor 142 will be tasked with addressing the problems occurring during the job and/or identified in the report before the contractor 142 is approved for future jobs.

After the job is complete, the method 200 may include scanning the identification devices 143, 147, 151 a third time to produce third identification information, as at 240. In at least one embodiment, the identification devices 143, 147, 151 may be scanned as the contractor 142, the personnel 146, and the equipment 150 are leaving the jobsite. The method 200 may also include transmitting the third identification information from the scanning device to the client central computer 110, the client location computer 120, and/or the contractor computer 140, as at 242. Thus, the third identification information from the scanning device may be received at the client central computer 110, the client location computer 120, and/or the contractor computer 140.

The client central computer 110, the client location computer 120, and/or the contractor computer 140 may determine that the job is complete based upon the third identification information. The client central computer 110 and/or the client location computer 120 may also end/terminate the authorization for the contractor 142, the personnel 146, and the equipment 150 based upon the third identification information, such that the contractor 142, the personnel 146, and the equipment 150 may no longer have authorization to be at the jobsite.

The method 200 may also include notifying the person in charge of the job 112 and/or the contractor 142 that the job is complete, and that the contractor 142, his/her personnel 146, and the equipment 150 no longer have authorization to be at the jobsite, as at 244.

FIG. 3 illustrates a schematic view of a computing system 300 for performing the method 200, according to an embodiment. The computing system 300 may be illustrative of the client central computer 110, the client location computer 120, and/or the contractor computer 140. The computing system 300 may include a computer or computer system 301A, which may be an individual computer system 301A or an arrangement of distributed computer systems. The computer system 301A includes one or more analysis modules 302 that are configured to perform various tasks according to some embodiments, such as one or more methods disclosed herein. To perform these various tasks, the analysis module 302 executes independently, or in coordination with, one or more processors 304, which is (or are) connected to one or more storage media 306. The processor(s) 304 is (or are) also connected to a network interface 307 to allow the computer system 301A to communicate over a data network 309 with one or more additional computer systems and/or computing systems, such as 301B, 301C, and/or 301D (note that computer systems 301B, 301C and/or 301D may or may not share the same architecture as computer system 301A, and may be located in different physical locations, e.g., computer systems 301A and 301B may be located in a processing facility, while in communication with one or more computer systems such as 301C and/or 301D that are located in one or more data centers, and/or located in varying countries on different continents).

A processor can include a microprocessor, microcontroller, processor module or subsystem, programmable integrated circuit, programmable gate array, or another control or computing device.

The storage media 306 can be implemented as one or more computer-readable or machine-readable storage media. Note that while in some example embodiments of FIG. 3 storage media 306 is depicted as within computer system 301A, in some embodiments, storage media 306 may be distributed within and/or across multiple internal and/or external enclosures of computing system 301A and/or additional computing systems. Storage media 306 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 300 contains one or more jobsite management module(s) 308. In some embodiments, the jobsite management module 308 may be used to perform at least some aspects of one or more embodiments of the method 200 disclosed herein.

It should be appreciated that computing system 300 is but one example of a computing system, and that computing system 300 may have more or fewer components than shown, may combine additional components not depicted in the example embodiment of FIG. 3, and/or computing system 300 may have a different configuration or arrangement of the components depicted in FIG. 3. The various components shown in FIG. 3 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the invention.

Geologic interpretations, models and/or other interpretation aids may be refined in an iterative fashion; this concept is applicable to methods as discussed herein. This can include use of feedback loops executed on an algorithmic basis, such as at a computing device (e.g., computing system 300, FIG. 3), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving a list of personnel that will perform a job, wherein the list of personnel is transmitted from a contractor using a contractor web access application on a contractor computer to a client computer;
receiving a list of equipment that will perform the job, wherein the list of equipment is transmitted from the contractor using the contractor web access application on the contractor computer to the client computer, and wherein the list of equipment comprises information about the equipment;
providing a plurality of identification devices to the contractor, wherein a first of the identification devices is to be worn by the contractor, a second of the identification devices is to be worn by one of the personnel, and a third of the identification devices is to be coupled to the equipment;
scanning the identification devices a first time to produce first identification information when the contractor, the personnel, and the equipment arrive at a jobsite;
comparing, using the client computer, the first identification information to the list of personnel and the list of equipment;
determining, using the client computer, that the personnel in the first identification information match the personnel listed in the list of personnel based upon the comparison;
determining, using the client computer, that the equipment in the first identification information matches the equipment listed in the list of equipment based upon the comparison; and
granting the contractor authorization to commence the job based at least partially upon the determination that the personnel in the first identification information match the personnel listed in the list of personnel and the determination that the equipment in the first identification information matches the equipment listed in the list of equipment.

2. The method of claim 1, wherein the information about the equipment comprises a certification of the equipment and a validity period for the certification.

3. The method of claim 1, further comprising:
determining, using the client computer, that the personnel in the list of personnel are approved to perform the job by comparing past experience and certifications of the personnel to first predetermined standards; and
determining, using the client computer, that the equipment in the list of equipment is approved to perform the job by comparing certifications of the equipment to second predetermined standards.

4. The method of claim 3, further comprising:
determining that an incident occurs during the job that delays completion of the job; and
determining when a portion of the job is completed.

5. The method of claim 4, further comprising generating a report using the client computer, wherein the report comprises the list of personnel, the list of equipment, the determination that the personnel in the first identification information match the personnel listed in the list of personnel, the determination that the equipment in the first identification information matches the equipment listed in the list of equipment, an indication that the incident occurred, and an indication that the portion of the job is completed.

6. The method of claim 1, further comprising scanning the identification devices a second time to produce second identification information when the contractor, the personnel, and the equipment have completed the job and are leaving the jobsite.

7. The method of claim 6, further comprising notifying the client computer and notifying the contractor computer that the job is complete and the contractor, the personnel, and the equipment are leaving the jobsite.

8. A method for moving a land rig, comprising:
determining that a contractor is approved to move the land rig;
providing the contractor access to a contractor web access application on a contractor computer after the contractor is approved to move the land rig;
receiving a list of personnel that will move the land rig from the contractor, wherein the list of personnel is transmitted by the contractor through the contractor web access application to a client computer;
receiving a list of equipment that will move the land rig from the contractor, wherein the list of equipment is transmitted by the contractor through the contractor web access application to the client computer, and wherein the list of equipment comprises a certification of the equipment and a validity period for the certification;
determining, using the client computer, that the personnel in the list of personnel are approved to perform the job by comparing past experience and certifications of the personnel to first predetermined standards;
determining, using the client computer, that the equipment in the list of equipment is approved to perform the job by comparing certifications of the equipment to second predetermined standards;
providing a plurality of identification devices to the contractor, wherein a first of the identification devices is to be worn by the contractor, a second of the identification devices is to be worn by one of the personnel, and a third of the identification devices is to be coupled to the equipment;
scanning the identification devices a first time to produce first identification information when the contractor, the personnel, and the equipment arrive at a location of the land rig;
comparing, using the client computer, the first identification information to the list of personnel and the list of equipment;
determining, using the client computer, that the personnel in the first identification information match the personnel listed in the list of personnel based upon the comparison;
determining, using the client computer, that the equipment in the first identification information matches the equipment listed in the list of equipment based upon the comparison; and
granting the contractor authorization to commence moving the land rig based at least partially upon the determination that the personnel in the list of personnel are approved to move the land rig, the determination that the equipment in the list of equipment is approved to move the land rig, the determination that the personnel in the first identification information match the personnel listed in the list of personnel, and the determination that the equipment in the first identification information matches the equipment listed in the list of equipment.

9. The method of claim 8, wherein the list of personnel comprises the past experience and certifications of the personnel.

10. The method of claim 8, wherein the first and second predetermined standards are made by a company that hires the contractor.

11. The method of claim 8, wherein the first and second predetermined standards are made by an organization or association.

12. The method of claim 8, further comprising notifying the contractor and a client that the personnel and the equipment have arrived at the location of the land rig.

13. The method of claim 8, further comprising:
determining that an incident occurs while moving the land rig that delays moving the land rig; and
determining that the land rig has been moved.

14. The method of claim 13, further comprising generating a report using the client computer, wherein the report comprises the list of personnel, the list of equipment, the determination that the personnel in the first identification information match the personnel listed in the list of personnel, the determination that the equipment in the first identification information matches the equipment listed in the list of equipment, an indication that the incident occurred, and an indication that land rig has been moved.

15. The method of claim 8, further comprising:
scanning the identification devices a second time to produce second identification information after the contractor, the personnel, and the equipment have moved the land rig; and
notifying the client computer and notifying the contractor computer, via the contractor web access application, that the land rig has been moved and the contractor, the personnel, and the equipment are leaving.

16. A system for moving a land rig, comprising:
a scanning device configured to scan a plurality of identification devices a first time to produce first identification information, wherein a first of the identification devices is worn by a contractor, a second of the identification devices is worn by personnel of the contractor, and a third of the identification devices is coupled to equipment; and
a client computer configured to perform operations, the operations comprising:
receiving a list of personnel that will move the land rig from the contractor, wherein the list of personnel comprises the personnel that wears the second identification device;
receiving a list of equipment that will move the land rig from the contractor, wherein the list of equipment comprises the equipment that has the third identification device coupled thereto;
comparing the first identification information to the list of personnel and the list of equipment;
determining that the personnel in the first identification information match the personnel listed in the list of personnel based upon the comparison;
determining that the equipment in the first identification information matches the equipment listed in the list of equipment based upon the comparison; and
granting the contractor authorization to commence moving the land rig based at least partially upon the determination that the personnel in the first identification information match the personnel listed in the list of personnel and the determination that the equipment in the first identification information matches the equipment listed in the list of equipment.

17. The system of claim 16, wherein the scanning device is configured to scan the identification devices the first time when the contractor, the personnel, and the equipment arrive at a location of the land rig.

18. The system of claim 16, wherein the scanning device is configured to scan the identification devices the second time when the contractor, the personnel, and the equipment leave the location of the land rig.

19. The system of claim 16, wherein the operations further comprise:
determining that the personnel in the list of personnel are approved to move the land rig by comparing past experience and certifications of the personnel to first predetermined standards; and
determining that the equipment in the list of equipment is approved to move the land rig by comparing certifications of the equipment to second predetermined standards.

20. The system of claim 19, wherein the operations further comprise generating a report, wherein the report comprises the list of personnel, the list of equipment, the determination that the personnel in the first identification information match the personnel listed in the list of personnel, the determination that the equipment in the first identification information matches the equipment listed in the list of equipment, and an indication that land rig has been moved.
